(19) United States
(12) Patent Application Publication
(10) Pub. No.: US 2012/0006630 A1
(43) Pub. Date: Jan. 12, 2012

(54) ELEVATOR GOVERNOR DEVICE

(76) Inventors: Min Allan Wang, Shanghai (CN); Li Haiyun, Ningbo (CN)

(21) Appl. No.: 13/258,026

(22) PCT Filed: Jun. 12, 2009
(86) PCT No.: PCT/US09/47170

§ 371 Date: Sep. 21, 2011

(51) Int. Cl. B66B 1/32

(52) U.S. Cl. 187/350

(57) ABSTRACT

An exemplary elevator governor device includes a sheave that is configured to move responsive to movement of a rope that moves with an elevator car. A stop member selectively moves into an engaged position in which the stop member is positioned to engage a portion of the rope to prevent movement of the rope. The stop member has a generally cylindrical outer surface for engaging the rope.

### BACKGROUND

Elevator systems have a variety of components for controlling the movement or position of the elevator car. An elevator governor is one such device. Elevator governors are used to protect against overspeed situations.

Typical elevator governors include a rope that moves with the elevator car. The governor rope follows a path around a governor sheave and a tension sheave. In the event that the elevator car moves faster than desired, the corresponding movement of the governor rope triggers the governor device. Safety braking devices are then actuated to bring the elevator car to a stop.

With the introduction of machine roomless elevator systems, it has become desirable to make elevator governor devices that can be automatically reset without requiring a mechanic or technician to manually manipulate governor components. There are various challenges presented when trying to make an automatically resettable governor device.

### SUMMARY

An exemplary elevator governor device includes a sheave that is configured to move responsive to movement of a rope that moves with an elevator car. A stop member selectively moves into an engaged position in which the stop member is positioned to engage a portion of the rope to prevent movement of the rope and ultimately stop movement of the elevator car. The stop member has a generally cylindrical outer surface for engaging the rope.

The various features and advantages of the disclosed example will become apparent to those skilled in the art from the following detailed description. The drawings that accompany the detailed description can be briefly described as follows.

### BRIEF DESCRIPTION OF THE DRAWINGS

FIG. 1 illustrates selected portions of an example elevator system.

FIG. 2 illustrates an example governor device designed according to an embodiment of this invention.

FIG. 3 illustrates an example stop member useful in the embodiment of FIG. 2.

### DETAILED DESCRIPTION

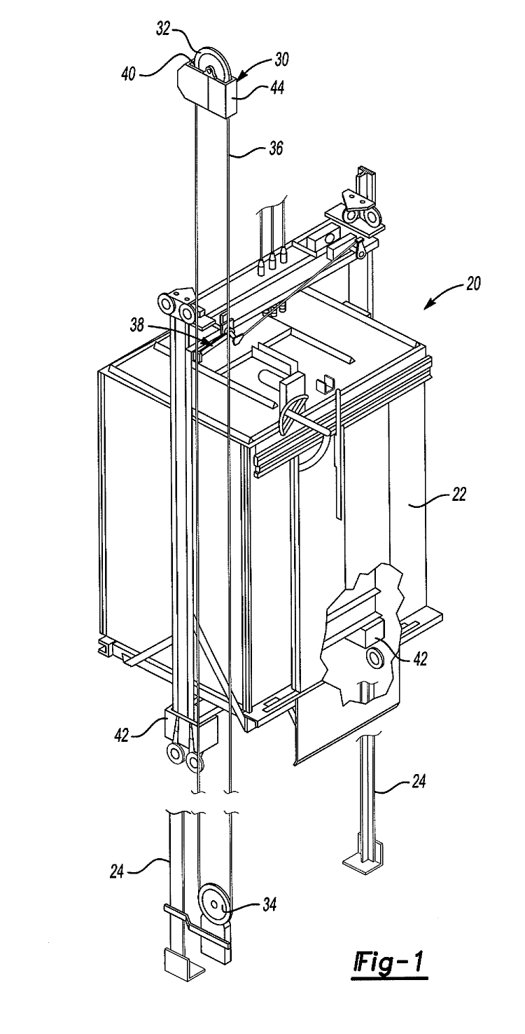

FIG. 1 shows selected portions of an elevator system 20. An elevator car 22 is situated for movement along guiderails 24.

A governor device 30 is operative to protect against the elevator car 22 moving at a speed that is above a desired threshold speed. The governor device 30 includes a governor sheave 32 and a tension sheave 34 positioned near opposite ends of the hoistway (not illustrated) within which the elevator car 22 is situated. A governor rope 36 follows a path at least partially around the governor sheave 32 and the tension sheave 34. The governor rope 36 is associated with a linkage 38 that is supported on the elevator car 22 such that the governor rope 36 is configured to move responsive to movement of the elevator car 22.

In the event of an overspeed condition, the governor device 30 is triggered and a stop member 40 engages the rope 36 to prevent movement of the rope 36. As the elevator car 22 continues to move, the relative movement between the elevator car 22 and the governor rope 36 causes movement of the linkage 38 in a manner that activates safety braking devices 42. In the illustrated example, the safety braking devices 42 engage surfaces on the guiderails 24 to prevent further movement of the elevator car 22.

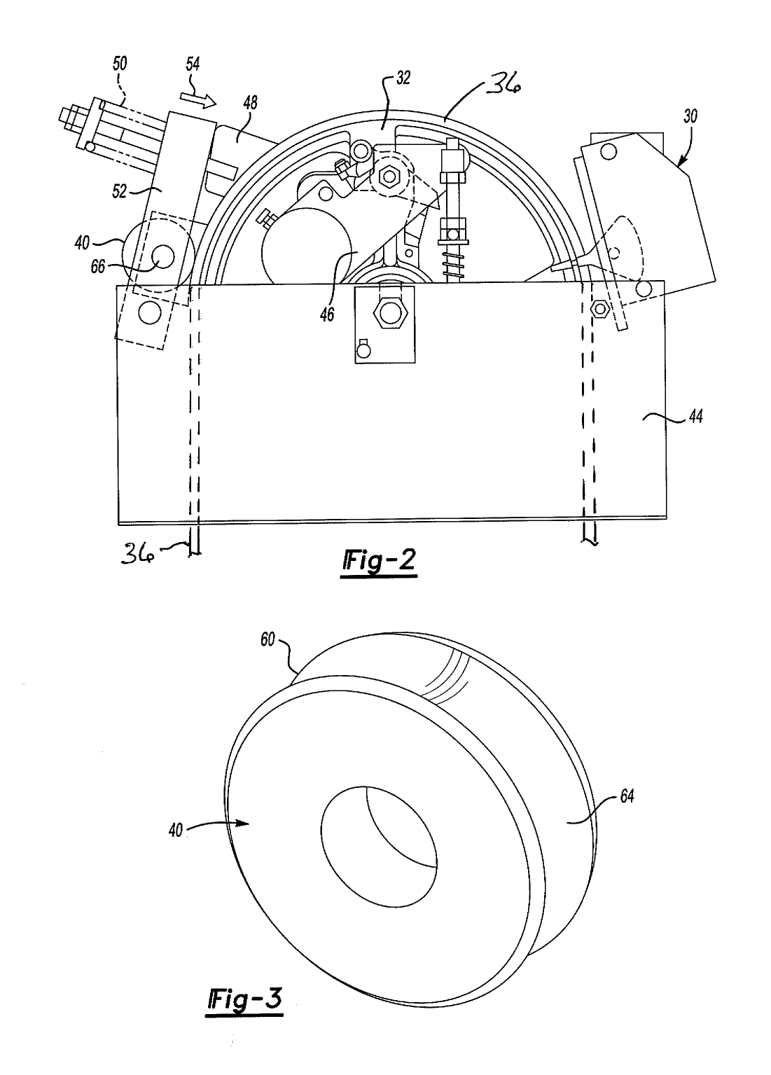

FIG. 2 illustrates one example governor device 30. This example includes a housing 44 that supports the governor sheave 32 and a triggering or tripping mechanism 46 that is configured to respond to an overspeed condition. The triggering mechanism 46 is configured to detect when the governor sheave 32 is moving at a speed above a desired threshold speed responsive to movement of the governor rope 36 moving with the elevator car 22. In this example, the triggering mechanism 46 releases a restraining member 48 that normally resists the bias of a biasing mechanism 50 that biases the stop member 40 into the engaged position where it would engage the rope 36 to prevent the rope from moving.

In the example of FIG. 2, the biasing mechanism 50 includes a spring. The spring urges the stop member 40 toward the governor sheave 32. One end of the spring in this example is received against a moveable support surface 52 upon which the stop member 40 is also supported. The restraining member 48 normally holds back the support surface 52 against the bias of the biasing mechanism 50 to keep the stop member 40 in a non-engaged position where it is clear of the rope 36.

During an overspeed condition the tripping mechanism 46 releases the restraining member 48 which allows the biasing mechanism 50 to urge the stop member 40 in the direction schematically shown by the arrow 54. In the example of FIG. 2, the stop member 40 moves in a radial direction toward a center of the governor sheave 32. The stop member 40 in this example engages a portion of the rope 36 that is on the sheave 32. In this example, the governor sheave 32 is a stop surface positioned on an opposite side of the rope 36 from the stop member 40 when the stop member 40 moves into the engaged position.

The stop member 40 in this example comprises a roller having a generally cylindrical outer surface 60 as can best be appreciated in FIG. 3. The outer surface 60 engages the rope 36. The engagement between the stop member 40 and the rope 36 in the illustrative example comprises rolling friction. Such contact between the roller-shaped stop member 40 and the rope 36 allows for automatically resetting the governor device 30 after it has been actuated and when it is desirable to once again move the elevator car 22. In particular, the friction force between the stop member 40 and the rope 36 is relatively small when considered during an automatic governor reset operation. The roller-shaped stop member 40 provides a sufficient frictional force to prevent movement of the rope 36 when needed, yet allows for automatically resetting the governor device without having to overcome significant friction forces at the interface between the stop member 40 and the rope 36, as is the case, for example, in safety configurations having a rectangular stop member.

In the example of FIG. 3, the outer surface 60 includes a groove 64 that has a contour corresponding to an exterior of the rope 36. For example, groove 64 may be concave, or it may be V-shaped. In this example, the stop member 40 is rotatable about an axis 66 that is supported on the moveable support surface 52. The forces associated with the urging of the biasing mechanism 50 (e.g., the spring) are sufficient to prevent movement of the rope 36 when the stop member 40 is moved into the engaged position. At the same time, the configuration of the stop member 40 in the illustrated embodiment allows for automatically resetting the governor device without having to overcome significant forces at the interface between the stop member 40 and the rope 36.

In one example, the stop member 40 comprises a steel disk. In another example, the stop member 40 comprises a hard plastic material.

The disclosed example provides the advantage of allowing for reliably and automatically resetting a governor device. Cost savings are also presented by the configuration of the stop member 40 as production of the stop member 40 is cost effective and can be accomplished using relatively inexpensive machining techniques.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator governor device, comprising:
a sheave configured to move responsive to a rope that moves with an elevator car; and
a stop member that selectively moves into an engaged position in which the stop member is positioned to engage a portion of the rope to prevent movement of the rope, the stop member having a generally cylindrical outer surface for engaging the rope.

2. The device of claim 1, wherein the stop member engaged position is at a location adjacent the sheave.

3. The device of claim 2, comprising a biasing mechanism that biases the stop member into the engaged position and wherein the biasing mechanism causes the stop member to move in a radial direction toward a center of the sheave as the stop member moves into the engaged position.

4. The device of claim 1, comprising a stop surface positioned to be on an opposite side of the portion of the rope from the stop member in the engaged position.

5. The device of claim 4, wherein the stop surface comprises the sheave.

6. The device of claim 1, comprising
a biasing mechanism that biases the stop member into the engaged position;
a restraining member that prevents the stop member from moving into the engaged position; and
a tripping mechanism that releases the restraining member and allows the biasing mechanism to bias the stop member into the engaged position responsive to an undesired movement of an associated elevator car.

7. The device of claim 6, wherein the biasing mechanism comprises a spring.

8. The device of claim 6, wherein the tripping mechanism and the restraining member are automatically resettable.

9. The device of claim 1, wherein the stop member is automatically moved into the engaged position and automatically resettable into a non-engaged position.

10. The device of claim 1, wherein the stop member outer surface includes a groove corresponding to an outer surface of the rope.

11. The device of claim 1, wherein the stop member comprises steel.

12. The device of claim 1, wherein the stop member comprises plastic.

13. The device of claim 1, wherein the stop member is supported on a moveable support surface that moves with the stop member as the stop member moves into the engaged position.

14. The device of claim 13, wherein the stop member is rotatable relative to the support surface.

15. The device of claim 1, wherein the stop member prevents movement of the rope because of rolling friction between the rope and the stop member.
